(19) United States
(12) Patent Application Publication
(10) Pub. No.: US 2004/0149661 A1
(43) Pub. Date: Aug. 5, 2004

(54) Effect of cations on activated sludge characteristics

(75) Inventors: Chul Park, Daegu (KR); Mohammad M. Abu-Orf, Pitman, NJ (US); John T. Novak, Blacksburg, VA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: United States Filter Corporation, Palm Desert, CA

(21) Appl. No.: 10/764,281

(22) Filed: Jan. 23, 2004

Related U.S. Application Data
(60) Provisional application No. 60/442,342, filed on Jan. 24, 2003.

(51) Int. Cl. C02F 1/52

(52) U.S. Cl. 210/723

(57) ABSTRACT

A wastewater treatment facility incorporates a trivalent cation salt to promote coagulation of flocculent material. The trivalent cation salt is typically added between a primary and a secondary treatment stage in the wastewater treatment facility. The trivalent cation is typically an aluminum salt. The amount of trivalent cation can be optimized by targeting a (M/D)/T ratio of less than about 1.0, where M is a monovalent cation equivalent concentration and D is a divalent cation equivalent concentration in the wastewater and T is a mass of the trivalent cation in the sludge. The amount of trivalent cation can also be optimized by targeting a M/T ratio of less than about 1.0, where M is a monovalent cation equivalent concentration in the wastewater and T is a mass of the trivalent cation in the sludge.

### RELATED APPLICATIONS

This application claims priority under 35 U.S.C. § 119(e) to U.S. Provisional Application Serial No. 60/442,342, entitled “Effect of Cations on Activated Sludge Characteristics,” filed on Jan. 24, 2003, which is herein incorporated by reference in its entirety.

### BACKGROUND OF INVENTION

The invention relates to wastewater treatment systems and methods of treating wastewater and, particularly, to improving the quality of an effluent and the properties of flocculent material by utilizing a trivalent cation to promote coagulation of biocolloidal material.

### SUMMARY OF INVENTION

In one embodiment, the invention provides a waster treatment system comprising a trivalent coagulant source fluidly connected upstream of a secondary treatment stage. The trivalent coagulant source can be fluidly connected downstream of a primary treatment stage. The trivalent coagulant can comprise an aluminum salt.

In another embodiment, the invention is directed to a method of treating wastewater comprising adding a trivalent cation prior to flocculating sludge in a wastewater treatment facility. The trivalent cation can facilitate coagulation of biocolloidal material to form flocculent material.

In another embodiment, the invention is directed to a method of treating wastewater comprising adding a trivalent aluminum salt to wastewater to be treated prior to bacterial treatment, forming a flocculated sludge and dewatering the sludge. The trivalent aluminum salt can be added in an amount such that a ratio of the equivalents of any monovalent cations to any divalent cations relative to the mass of trivalent aluminum salt per mass of solids is less than about 1.0.

In another embodiment, the invention is directed to a method of treating wastewater comprising adding a trivalent cation to the wastewater and forming a flocculant material while maintaining a (M/D)/T ratio of less than about 1.0, wherein M represents monovalent cation equivalent concentration in the wastewater, D represents divalent cation equivalent concentration in the wastewater and T represent the mass of the trivalent cations in the flocculent material.

In another embodiment, the invention is directed to a method of treating a wastewater comprising adding a trivalent cation to the wastewater and forming a flocculant material while maintaining a MIT ratio of less than about 1.0, wherein M represents monovalent cation equivalent concentration in the wastewater and T represent the mass of the trivalent cations in the flocculent material.

In another embodiment, the invention is directed to a method of facilitating wastewater treatment comprising providing a trivalent cation to a wastewater treatment system for the purpose of promoting coagulation biocolloidal material. The method can further comprise providing instructions for use of the trivalent cation in promoting coagulation of biocolloidal material.

In another embodiment, the invention is directed to a method of facilitating wastewater treatment comprising supplying a trivalent cation to a wastewater treatment system in a quantity and at a location selected to promote coagulation of biocolloidal material.

In another embodiment, the invention is directed to a method of facilitating the coagulation of biocolloidal material in a wastewater of a wastewater treatment system comprising providing a trivalent cation to the wastewater treatment system.

### BRIEF DESCRIPTION OF DRAWINGS

The accompanying drawings are not intended to be drawn to scale. In the drawings, each identical or nearly identical component that is illustrated in various figures is typically represented by a like numeral. For purposes of clarity, not every component may be labeled in every drawing. In the drawings:

FIGS. 1A-1C are graphs showing capillary suction time changes in waste activated sludge from facility C (FIG. 1A); from facility G (FIG. 1B), and the other facilities (FIG. 1C) during shear tests at G=500/s;

FIG. 2 is a graph showing the effect of potassium cation release into activated sludge solution on sludge dewatering as characterized by specific resistance to filtration;

FIGS. 3A-3B are graphs showing the effect of the ratio of monovalent to divalent cations on soluble biopolymers in the waste activated sludge (FIG. 3A) and in the effluent (FIG. 3B);

FIGS. 4A-4B are graphs showing the sum of floc iron and aluminum with effluent biopolymer based on one gram total solids (FIG. 4A) and one gram ash (FIG. 4B);

FIGS. 5A-5B are graphs showing floc utilizing aluminum (FIG. 5A) and iron (FIG. 5B) with effluent biopolymer;

FIG. 6 is a graph showing the influence of the ratio of monovalent cation to trivalent cation (M/T) in the ash on the biopolymer effluent;

FIG. 7 is a graph showing the influence of the ratio of monovalent cation to divalent cation to trivalent cation ((M/D)/T) in the ash on the biopolymer effluent;

FIG. 8 is a graph showing the influence of measured aluminum in the floc ash on the volatile solids after passing it through a 1.5 micrometer filter;

FIG. 9 is a graph showing the fraction material passing through a 1.5 micrometer filter as a function of optimum iron chloride conditioner dose;

FIGS. 10A-10B are graphs showing optimum iron chloride doses for waste activated sludge protein (FIG. 10A) and polysaccharide (FIG. 10B);

FIG. 11 is a graph showing the decrease in necessary polymer dosage (along with resultant decrease in protein in the effluent) with increasing aluminum cation level; and

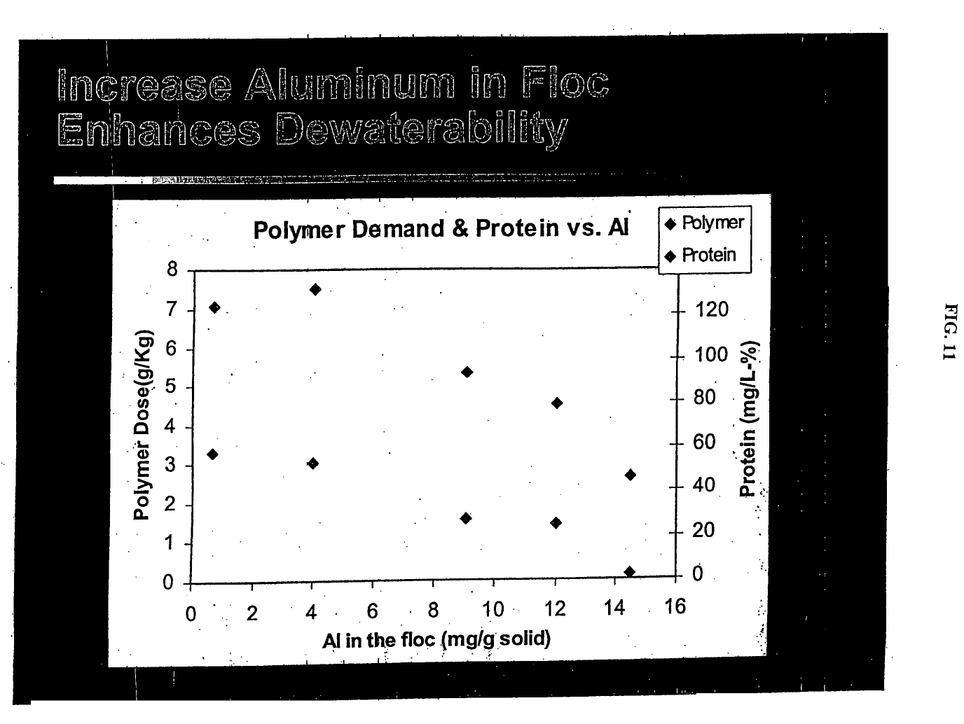

FIG. 12 is a graph showing the decrease in necessary FeCl₃ dosage (along with resultant decrease in protein in the effluent) with increasing aluminum cation level;

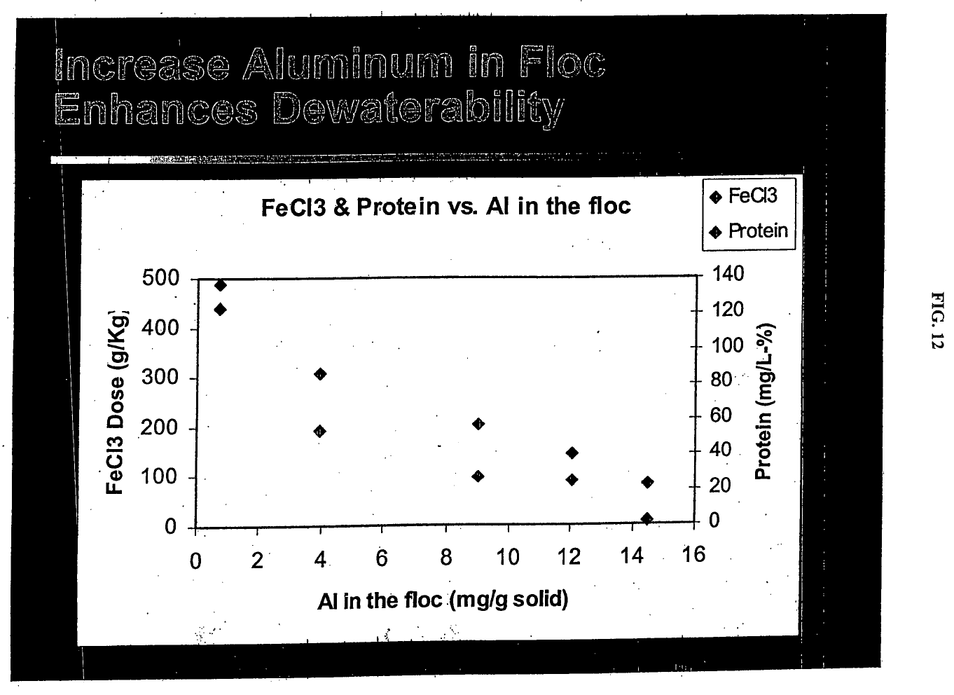

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Wastewater treatment plants (WWTP) or systems typically include a primary treatment stage followed by a secondary treatment stage and a tertiary or polishing treatment stage. Some wastewater treatment facilities also incorporate pretreatment stages for neutralization of acidic or basic wastewater, for grease removal, and for toxic substance removal. In the primary treatment stage, suspended solids are removed by clarification or settling utilizing, for example gravity sedimentation systems. This stage can also utilize grit chambers as well as chemical precipitation techniques. In some cases, the primary treatment stage can be used to remove phosphorus-based species by adding alum or water soluble iron salts.

The secondary treatment stage typically involves activated sludge treatment by suspension growth or by attached growth wherein bacterial organism promote decomposition of organic and/or inorganic compounds into waste activated sludge, flocculent material or floc. This floc which forms a precipitate is typically about 1.5% (wt.) solids. Microorganisms, extracellular polymeric substances (EPS) or exocellular biopolymers, and cations are major constituents of activated sludge floc or flocculent material. The secondary treatment can also include a clarifier or settling substage to increase or aggregate the solid mass of the floc and separate such from effluent water. The secondary treatment can also utilize a combination of aerobic and/or anaerobic digestion steps to further improve effluent quality. The settling time of floc during treatment can affect the efficiency of a wastewater treatment facility. To reduce settling time, additives can be used to promote aggregation of floc. After aggregation, the floc is typically dewatered. In some cases, for example, for reducing the volume of collected floc, thickeners or conditioners can be added to improve dewatering. Examples of typical conditioners include, but not limited to, polymers such as polyacrylamide. The floc can be further dewatered by centrifuging.

The final treatment stage typically involves disinfection of the effluent, by for example, halogenation or ultraviolet irradiation to kill any remnant pathogens before final water discharge.

In one or more embodiments in accordance with the present invention, a wastewater treatment facility comprises a waster treatment system comprising a trivalent coagulant source fluidly connected upstream of a secondary treatment stage. The trivalent coagulant source can be fluidly connected downstream of a primary treatment stage. In some embodiments, the trivalent coagulant promotes the aggregation or coagulation of waste activated sludge, biocolloidal material or flocculent material. The trivalent coagulating agent can be any trivalent cation such as, but not limited to those present in a trivalent metal cation salt (e.g., an iron salt or aluminum salt or potentially other salts of Group III metals or any combination of these), which is, preferably, non-toxic and/or can be legally and safely present in treated water to be discharged to water bodies. A preferred trivalent cation of the trivalent coagulating agent does not change valence when present in wastewater during aerobic or anaerobic digestion of the wastewater. The aluminum salt can comprise, for example, aluminum chloride or aluminum sulfate (alum) or other aluminum salts. A suitable iron salt can comprise iron chloride. The trivalent coagulating agent can be introduced into the wastewater treatment system as a solution or, preferably, as solid to minimize any additional water loading into the treatment system. The trivalent coagulating agent can be introduced, if desired, in a recycled waste activated sludge stream supplying bioorganisms to an activated sludge tank of the wastewater treatment system.

In another embodiment in accordance with the present invention, a method of treating wastewater comprises adding a trivalent cation prior to flocculating sludge in a wastewater treatment facility. The trivalent cation can facilitate coagulation of biocolloidal material to form flocculent material. Preferably, the trivalent coagulating agent binds or promotes binding of biocolloids, such as proteins and polysaccharides, in activated sludge. Even more preferable, the trivalent coagulating agent improves dewaterability of flocculent material by improving physical properties, such as mechanical strength, during dewatering by, for example, filtering or centrifuging operations. In other preferred embodiments, the trivalent coagulating agent improves the effluent water quality.

In yet another embodiment in accordance with the invention, a method of dewatering sludge comprises adding a trivalent aluminum salt to wastewater to be treated prior to bacterial treatment. The trivalent aluminum salt can be added in an amount such that a ratio of the equivalents of any monovalent cations to any divalent cations relative to the mass of trivalent aluminum salt per mass of solids is less than about 1.0, preferably, at less than about 0.5, more preferably at less than about 0.2, and even more preferably, less than about 0.1, to improve floc physical properties and improve effluent quality.

In another embodiment in accordance with the present invention, a method of facilitating removal of flocculent material from a wastewater comprises adding a trivalent cation to the wastewater and maintaining a (M/D)/T ratio of less than about 1.0 during flocculation, wherein M represents monovalent cation equivalent concentration in the wastewater, D represents divalent cation equivalent concentration in the wastewater and T represent the mass of the trivalent cations per unit mass of the flocculent material (as measured on a bone dry basis as “ash”). The ratio, (M/D)/T is preferably, less than about preferably, at less than about 0.5, more preferably at less than about 0.2, and even more preferably, less than about 0.1, to improve floc physical properties and improve effluent quality.

In still another embodiment in accordance with the present invention, a method of facilitating removal of flocculent material from a wastewater comprises adding a trivalent cation to the wastewater and maintaining a M/T ratio of less than about 1.0, wherein M represents monovalent cation equivalent concentration in the wastewater and T represent the mass of the trivalent cations per unit mass of the flocculent material. The ratio M/T is preferably, less than about preferably, at less than about 0.5, more preferably at less than about 0.2, and even more preferably, less than about 0.1, to improve floc physical properties and improve effluent quality.

In another embodiment in accordance with the invention, a method of facilitating wastewater treatment comprises providing a trivalent cation to a wastewater treatment system for the purpose of promoting coagulation of biocolloidal material. The method can further comprise providing instructions for use of the trivalent cation in promoting coagulation of biocolloidal material. In another embodiment in accordance with the invention, a method of facilitating wastewater treatment comprises supplying a trivalent cation to a wastewater treatment system in a quantity and at a location selected to promote coagulation of biocolloidal material.

In accordance with the invention and to show the utility of utilizing trivalent cations to facilitate flocculation, wastewater samples were collected from seven different full-scale WWTPs. Some plants were sampled twice and the first and second sampling are designated with 1 and 2. The samples consisted of the plant's influent (primary effluent), mixed liquor, waste activated sludge, and plant's effluent (secondary effluent). For all the samples, cations in solution were measured and dried waste activated sludge (WAS) was prepared for analysis of iron and aluminum in floc. In this study, the term ‘soluble’ or ‘solution’ refers to be the material that can be filtered through 0.45 μm filter. Prior to filtering, all the WAS samples were centrifuged at 9,460g for 15 minutes and the centrate was used for subsequent filtration (1.51 μm, 0.451 μm and 30K and 1K ultrafiltration). Unlike mono and divalent cations, soluble iron and aluminum were not detected in most of the aeration basin influents, indicating that they are primarily associated with solids or materials greater than 0.451 μm in the wastewater.

The sludge settling and dewatering properties were measured using mixed liquor and WAS, respectively. Shear tests and conditioning tests were also conducted using WAS. Soluble chemical oxygen demand (COD) and total suspended solids in secondary effluent were analyzed. Also, soluble protein and polysaccharide was measured using solution phase of WAS and secondary effluent.

Solution cations, sodium, potassium, ammonium, magnesium, and calcium were analyzed using a Dionex Ion Chromatograph. Floc cations, total iron and aluminum, in dry sludge were measured using EPA method 3050B (Acid digestion for metals analysis of soils, sediments, and sludges).

WAS was dried at 105° C. and the known amount of dried sludge was removed and underwent acid digestion. The samples were quantified using Atomic Absorption Spectrometer. Iron and aluminum in sludge solution were also measured using Atomic Absorption Spectrometer.

Total solids (TS), total suspended solids (TSS), mixed liquor suspended solids (MLSS), total volatile solids (VS), and volatile suspended solids (VSS) were measured according to Standard Methods (APHA, 1995). Sludge volume index (SVI) and soluble COD were measured based on methods 271 OD and 5220C of Standard Methods, respectively (APHA, 1995). The protein concentration was determined by the Hartree (1972) modification of the Lowry et al. (1951) method using bovine serum albumin as the standard. Polysaccharide was measured by the Dubois et al. (1956) method utilizing glucose as the standard.

Both ferric chloride and alum at concentrations of 100 g/L and a high charge cationic polymer, BC650 (Stockhausen), at 0.5% (w/w) were used as sludge conditioners (“trivalent cation coagulators”) in this study. Optimum doses of each conditioner were determined using capillary suction time (CST) test by obtaining the lowest CST reading. CST and specific resistance to filtration (SRF) were used as measures of the sludge dewatering rate according to method 2710G of Standard Methods (APHA, 1995) and method described by Christensen and Dick (1985), respectively. The shear test used the same procedure as that of Higgins and Novak (The Effect of Cations on the Settling and Dewatering of Activated Sludges: Laboratory Results, Water Environ. Res., 69, 215, 1997). A sludge sample was placed in a baffled container and stirred with a flat paddle mixer at G=500/sec. For each test, a 500 mL sample of WAS was placed into a 2L baffled cylinder and once mixing began, CST values were measured every 2 minutes for 8 minutes. The increase in CST with mixing time indicates the degree of sensitivity to shear.

The linear correlation matrix was computed using a statistic software (Minitab for Windows) and shown in Table 4. Correlations were considered statistically significant at a 0.95 probability level in this study. Correlations at two levels of significance (p<0.05 and p<0.01) are also indicated in Table 4.

The composition of WAS samples including mono and divalent cations in sludge solution and iron and aluminum in the dried sludges are listed in Table 1. A summary of dewatering properties, conditioning chemical requirements, and solution biopolymer in the WAS and secondary effluent are listed in Table 2.

TABLE 1
Characteristics of WAS from seven full-scale WWTPs

| | SRT | TS | VS | Na⁺ | K⁺ | NH₄⁺ | Mg²⁺ | Ca²⁺ | M/D | Al | Fe |
|---|---|---|---|---|---|---|---|---|---|---|---|
| Plant | (day) | (g/L) | (g/L) | (mg/L) | (mg/L) | (mg/L) | (mg/L) | (mg/L) | (eq/eq) | (mg/g TS) | (mg/g TS) |
| A1 | 18 | 14.98 | 10.23 | 296 | 29.7 | 2.95 | 19.2 | 35.1 | 4.1 | 14.5 | 24.5 |
| A2 | 28 | 18.74 | 13.91 | 579 | 27.2 | BDL | 20.1 | 39.4 | 7.2 | 9.2 | 15.8 |
| B1 | 11 | 6.57 | 3.18 | 1087 | 92.6 | BDL | 18.4 | 23.7 | 18.4 | 0.7 | 2.9 |
| B2 | 11 | 8.47 | 4.99 | 977 | 116 | BDL | 17.9 | 37.2 | 13.7 | 0.7 | 3.8 |
| C | 4 | 8.32 | 6.69 | 67.6 | 71.7 | 49.3 | 25.0 | 24.8 | 2.3 | 12.9 | 12.9 |
| D | 23 | 6.77 | 5.49 | 93.8 | 11.4 | BDL | 13.5 | 34.2 | 1.6 | 5.8 | 5.8 |
| E1 | 7 | 10.1 | 5.84 | 293 | 55.5 | N | 53.2 | 273 | 0.79 | 3.9 | 30.4 |
| E2 | 7 | 8.87 | 4.87 | 299 | 32.8 | 51.6 | 44.5 | 339 | 0.81 | 2.0 | 39.7 |
| F1 | 3 | 5.57 | 4.57 | 71.2 | 10.1 | 2.4 | 7.7 | 26.0 | 1.8 | 13.5 | 5.8 |
| F2 | 3 | 5.22 | 3.85 | 89.3 | 10.4 | 0.2 | 6.1 | 25.9 | 2.3 | 26.8 | 9.5 |
| G | 5 | 6.54 | 5.18 | 129 | 48.4 | 39.5 | 14.9 | 29.3 | 3.4 | 9.3 | 15.1 |

BDL: Below detection limit
N: Not quantified

TABLE 2
Characteristics of activated sludge process in seven full-scale WWTPs

| | | | | | Opt. | | | | |
|---|---|---|---|---|---|---|---|---|---|
| | | | Opt. | Opt. | Cationic | Solution | Solution | Effluent | Effluent |
| | CST | SRF | FeCl₃ | Alum | Polymer | protein* | polysaccharide* | Protein | polysaccharide |
| Plant | (sec) | (Tm/kg) | (mg/L) | (mg/L) | (mg/L) | (mg/L) | (mg/L) | (mg/L) | (mg/L) |
| A1 | 60 | 2.0 | 1200 | 1400 | 39.6 | 3.6 | 2.2 | 3.2 | 2.8 |
| A2 | 72 | 1.7 | 1120 | 1800 | 45.7 | 5.9 | 3.9 | 3.9 | 3.6 |
| B1 | 62 | 4.7 | 3200 | 1080 | 23.5 | 67 | 14 | 57 | 12 |
| B2 | 27 | 0.6 | 2400 | 1000 | 11.9 | 32 | 7.2 | 29 | 8.0 |
| C | 394 | 250 | 1200 | 2000 | 39.8 | 22 | 13 | 7.7 | 5.2 |
| D | 19 | 0.5 | 720 | 1000 | 3.98 | 1.2 | 4.3 | 3.5 | 3.3 |
| E2 | 58 | 13.3 | 1920 | 2200 | 27.8 | 17 | 13 | NA | NA |
| F1 | 45 | 5.7 | 400 | 680 | 10.9 | 3.1 | 2.5 | 1.9 | 3.1 |
| F2 | 27 | 1.1 | 400 | 800 | 6.5 | 0.7 | 2.4 | 1.8 | 4.2 |
| G | 92 | 120 | 1320 | 1200 | 35.2 | 18 | 11 | 7.6 | 6.9 |

*Protein and polysaccharide in the WAS solution
NA: Samples were not available.
Sludge E1 was not used for these analyses so E1 is omitted in Table 2.

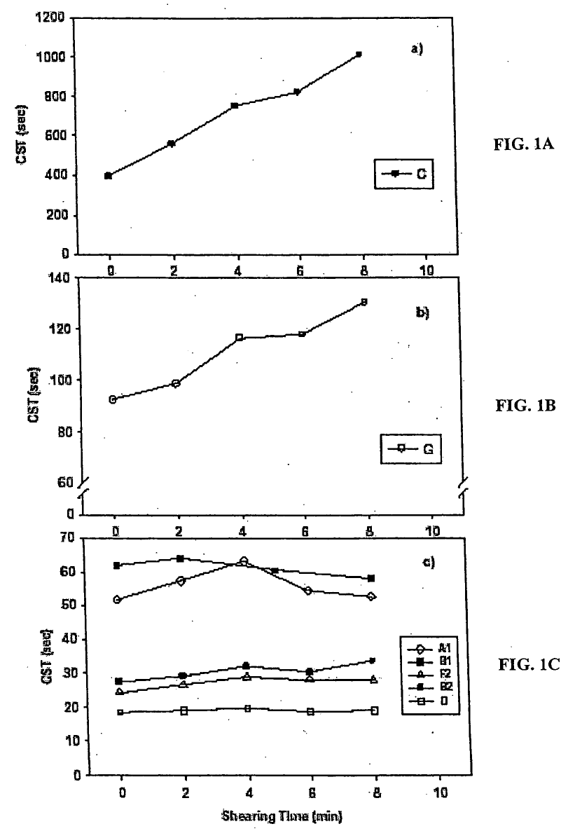

It can be seen from the data in Table 2 that the dewatering rates of WAS from plants C and G, described by CST and SRF, are quite different from those from other plants. The floc strength of these sludges was evaluated by conducting shear tests at G=500/sec and measuring the changes in CST over time. Data in FIG. 1 shows that WAS C and G were very sensitive to shear as indicated by a large increase in CST with mixing. The other sludges were more shear resistant (CST remained nearly constant) under the same conditions. M/D ratios did not account for the poor dewatering rates and weak floc strength of WAS C and G. As shown in Table 1, the M/D ratios of these sludges were 2.3 for sludge C and 3.4 for sludge G. These values are above the optimum of 2 recommended by Higgins and Novak (Dewatering and Settling of Activated Sludges: The Case for Using Cation Analysis, Water Environ. Res., 69, 225, 1997), but are comparable to some of the other sludges that were not shear sensitive. The only noticeable difference in cation contents for these sludges was that an abnormally high potassium concentration was found in the WAS, compared to its concentration in the plant influent.

Table 3 lists the potassium concentrations across each facility. The WAS K+ was approximately four times greater in the WAS for plants C and G, compared to the influent K+. Since K+ may be required by microorganisms for cell synthesis and can be present at high concentrations intracellularly, some stress to microbes might have been present in the influents to these two facilities that resulted in K+ being released into activated sludge solution.

TABLE 3
Potassium concentrations across a WWTP

| | | | | | K⁺ Ratio |
|---|---|---|---|---|---|
| | Influent | ML | WAS | Effluent | (WAS/Influent) |
| Plant | (mg/L) | (mg/L) | (mg/L) | (mg/L) | (mg/mg) |
| A1 | 18.8 | 22.3 | 29.7 | 22.0 | 1.58 |
| A2 | 18.1 | 22.0 | 27.2 | 20.5 | 1.51 |
| B1 | N | 94.0 | 92.6 | 97.2 | — |
| B2 | N | 111.4 | 115.6 | 116.6 | — |
| C | 15.6 | 28.0 | 71.7 | 15.7 | 4.59 |
| D | 7.2 | 9.1 | 11.4 | 8.6 | 1.58 |
| E1 | 55.9 | 34.0 | 55.5 | 26.2 | 0.99 |
| E2 | 19.2 | 32.0 | 32.8 | NA | 1.70 |
| F1 | 9.6 | 10.8 | 10.1 | 7.7 | 1.06 |
| F2 | 9.7 | 11.1 | 10.4 | 9.37 | 1.07 |
| G | 12.9 | 31.4 | 48.4 | 26.5 | 3.78 |

N: Not quantified
NA: Samples were not available

TABLE 4
Linear coefficients of correlation for activated sludge from 7 full-scale WWTPs

| | soluble | soluble p. | soluble | effluent | opt. | opt. | cationic | |
|---|---|---|---|---|---|---|---|---|
| | protein | saccharide | bipolmer | biopolmer | FeCl₃ | Alum | polymer | |
| | (mg/L) | (mg/L) | (mg/L) | (mg/L) | (mg/L) | (mg/L) | (mg/L) | VS/TS % |
| sol. p. saccharide | 0.73^{a} | | | | | | | |
| sol. biopolymer | 0.99^{b} | 0.82^{b} | | | | | | |
| eff. biopolymer | 0.98^{b} | 0.67^{a} | 0.95^{b} | | | | | |
| opt. FeCl₃ | 0.92^{b} | 0.69^{a} | 0.91 | 0.95^{b} | | | | |
| opt. Alum | 0.02 | 0.51 | 0.12^{b} | −0.12 | 0.19 | | | |
| opt. cat.polymer | 0.08 | 0.30 | 0.12 | −0.07 | 0.16 | 0.73^{a} | | |
| % VS/TS | −0.72^{a} | −0.48 | −0.71^{a} | −0.89^{b} | −0.88^{b} | −0.18 | −0.02 | |
| % (TS-TSS)/TS | 0.91^{b} | 0.61 | 0.89^{b} | 0.98^{b} | 0.97^{b} | 0.03 | −0.04 | −0.92^{b} |
| Al | −0.61 | −0.52 | −0.62 | −0.71^{a} | −0.83^{b} | −0.30 | −0.13 | 0.72^{a} |
| Fe | −0.47 | 0.10 | −0.37 | −0.66^{a} | −0.30 | 0.72^{a} | 0.68^{a} | 0.23 |
| Al + Fe | −0.72^{a} | −0.30 | −0.67^{a} | −0.81^{b} | −0.77^{b} | 0.23 | 0.32 | 0.66^{a} |
| Na | 0.78^{b} | 0.30 | 0.72^{a} | 0.85^{b} | 0.86^{b} | −0.05 | 0.04 | −0.80^{b} |
| K | 0.82^{b} | 0.60 | 0.82^{b} | 0.79^{a} | 0.83^{b} | 0.08 | 0.13 | −0.57 |
| Mg | 0.21 | 0.63 | 0.30 | 0.28 | 0.44 | 0.87^{b} | 0.45 | −0.50 |
| Ca | −0.03 | 0.39 | 0.06 | −0.26 | 0.21 | 0.61 | 0.09 | −0.44 |
| M/D | 0.84^{b} | 0.30 | 0.77^{b} | 0.94^{b} | 0.83^{b} | −0.21 | 0.00 | −0.69 |

| | (TS-TSS)/ | Al | Fe | Al + Fe | Na | K | Mg | Ca |
|---|---|---|---|---|---|---|---|---|
| | TS % | (mg/gash) | (mg/gash) | (mg/gash) | (mg/L) | (mg/L) | (mg/L) | (mg/L) |
| sol. p. saccharide | | | | | | | | |
| sol. biopolymer | | | | | | | | |
| eff. biopolymer | | | | | | | | |
| opt. FeCl₃ | | | | | | | | |
| opt. Alum | | | | | | | | |
| opt. cat.polymer | | | | | | | | |
| % VS/TS | | | | | | | | |
| % (TS-TSS)/TS | | | | | | | | |
| Al | −0.77^{b} | | | | | | | |
| Fe | −0.45 | 0.14 | | | | | | |
| Al + Fe | −0.82^{b} | 0.80^{b} | 0.71^{a} | | | | | |
| Na | 0.88^{b} | −0.72^{a} | −0.55 | −0.85^{b} | | | | |
| K | 0.77b | −0.59 | −0.40 | −0.66^{a} | 0.75^{a} | | | |
| Mg | 0.34 | −0.58 | 0.55 | −0.07 | 0.14 | 0.21 | | |
| Ca | 0.22 | −0.40 | 0.50 | 0.02 | −0.05 | −0.12 | 0.85^{b} | |
| M/D | 0.85^{b} | −0.59 | −0.66^{a} | −0.82^{b} | 0.96^{b} | 0.77^{b} | −0.77 | −0.28 |

Levels of significance: a (p = 0.05) and b (p = 0.01)

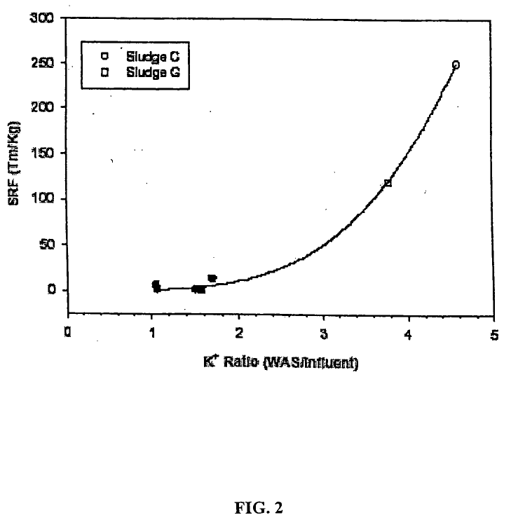

When spikes of electrophilic toxic chemicals are added to activated sludges, bacteria can release K+ as part of a specific protective stress response, causing sludge deflocculation. K+ can be released during short-term anaerobic storage of activated sludge and the release can be as a result of the strict aerobes losing their ability to keep internal K+ under anaerobic conditions. High ammonium level in WAS C and G might suggest that there was either lack of nitrification in these facilities or unwanted reaction during sample transport from the possibly reduced oxygen concentration. The exact cause of the unique K+ response in plants C and G could not be determined in this study but FIG. 2 illustrates that the ratio of K+ in WAS to that in influent produces a useful indicator of poor dewatering rates of WAS C and G. Although the data is limited, it appears that the changes in K+ across a plant might be indicators of both microbial stress and poor sludge dewatering. In addition, Table 2 indicates that solution biopolymer in the WAS and effluent from these two facilities, like their poor dewatering rates, was much higher than those from other plants except for one facility, plant B. These results further suggest that sludge characteristics associated with K+ release across the treatment plant might be somewhat different from problems caused by other influent properties. As a result, data points representing wastewater from plants C and G are shown separately in many of the figures.

Protein and polysaccharide was quantified in the solution phase of WAS and in secondary effluent from each WWTP. These unattached biopolymers can be used for characterizing the extent of biopolymer binding to activated sludge floc. Consequently, various cation contents in each WWTP were compared with soluble biopolymers in order to assess the impact of cations on activated sludge flocculation.

The M/D ratio can be used as an indicator of the potential for cations to affect biological flocculation. A wide range of M/D ratios was obtained from the sludges investigated and the ratios were utilized to determine if M/D was related to the solution biopolymer content in activated sludge.

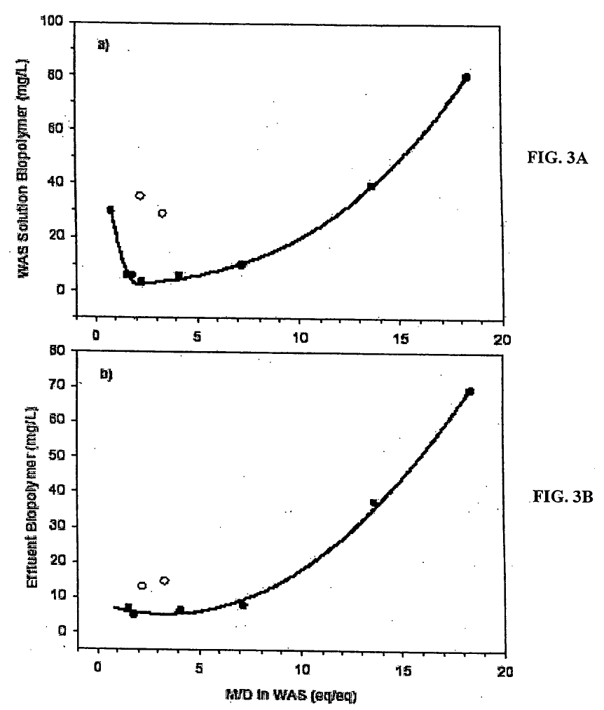

As can be seen in Table 2, large amounts of biopolymer were found in the WAS solution and in the effluents from WWTP B, implying that substantial fraction of protein and polysaccharide remained unflocculated and washed out in the effluent. Plant B is a facility that receives the wastewater from a meat processing industry as a major influent source. This plant had an extremely high influent Na+ concentration and the lowest floc iron and aluminum of any of the plants. A relatively high K+ content was also found. Accordingly, the M/D ratios for WAS B1 and B2 were 18.4 and 13.7, respectively and they were well beyond the M/D ratios of other sludges. Detection of high concentrations of solution biopolymer coupled with high monovalent cations in the influent is consistent with prior findings by Higgins and Novak (Dewatering and Settling of Activated Sludges: The Case for Using Cation Analysis, Water Environ. Res., 69, 225, 1997) dealing with the effect of cations on activated sludge. The linear correlation data shown in Table 4 also indicates that soluble biopolymer in the WAS and effluent are both positively correlated with the M/D. These relationships are shown graphically in FIG. 3. In general, as the M/D ratio increased, more biopolymer remained in the solution phase, implying that WWTP with high M/D produced sludge with weak biopolymer binding. It is also worthwhile noting that effluent biopolymer of B I and B2, even from the same WWTP, differed significantly as the cation composition and M/D ratio varied.

FIG. 3a shows that WAS E, in spite of having the lowest M/D ratio, contained quite large amount of solution biopolymer. Higgins and Novak also noticed poorer dewatering rates of activated sludge at very low M/D values. This data tend to indicate that M/D ratio less than the optimum value might also cause deterioration in sludge properties.

The M/D ratio alone does not explain all the differences in effluent and sludge characteristics. An example was the wastewater sampled from plant A. High concentrations of Na+ were found at this facility, which corresponded to WAS M/D ratios for A1 and A2 of 4.1 and 7. 1, respectively. Although both the M/D ratios are much higher than optimum, protein and polysaccharide concentrations found in the effluent are comparable to those from plants with lower M/D ratios. An important difference between the sludges from plant A and plant B is that the iron and aluminum content of plant A was much greater than from plant B and this is believed to account for the different sludge and effluent characteristics.

The concentrations of floc iron and aluminum in seven different WWTPs are listed in Table 1. Widely varying amounts of both iron and aluminum were found, even for activated sludges taken from the same WWTP at different times.

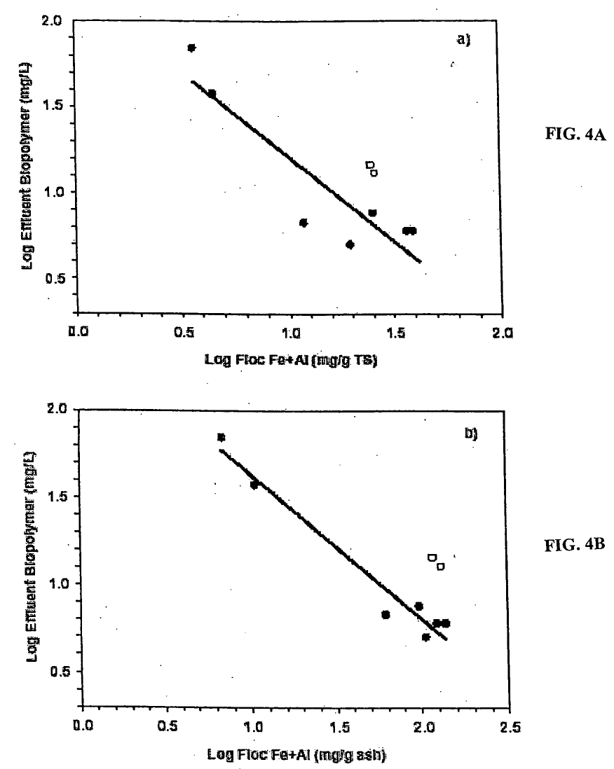

In this study, four WWTPs (A, B, E and F) were sampled twice. The sampling time, the percentage of ash in WAS, and the sum and ratio of iron and aluminum are listed in Table 5. The sum of iron and aluminum and ash content were generally greater in sludges collected during the warmer period. The mass of metals in sludge is usually expressed on a TS basis (Table 1). If increased iron and aluminum were not really due to the increased inflow of these materials, the inorganic cations are more likely associated with ash content in the mixed liquor. Therefore, units of mg cations/gm ash were used to express iron and aluminum concentrations. The data in FIG. 4 shows the effect of iron and aluminum on effluent biopolymer using both units of mg per unit of ash and units of mg per unit of TS. As can be seen in the figure, units on an ash basis better describes the relationship between trivalent cations and effluent biopolymer.

TABLE 5
Variations in floc cations and ash content
in the WAS at different times

| | Ash/TS | Al + Fe | Al + Fe | Al/Fe | Month of |
|---|---|---|---|---|---|
| sludge | (%) | (mg/g TS) | (mg/g ash) | (mg/mg) | Sampling |
| A1 | 32 | 39.0 | 123 | 0.59 | June |
| A2 | 26 | 25.0 | 97 | 0.58 | January |
| B1 | 52 | 3.6 | 6.9 | 0.24 | July |
| B2 | 41 | 4.5 | 10.8 | 0.17 | November |
| F1 | 18 | 19.3 | 108 | 2.32 | January |
| F2 | 26 | 36.3 | 138 | 2.83 | September |

Data For WAS E1 and E2 are not shown in this table since they were sampled at similar time

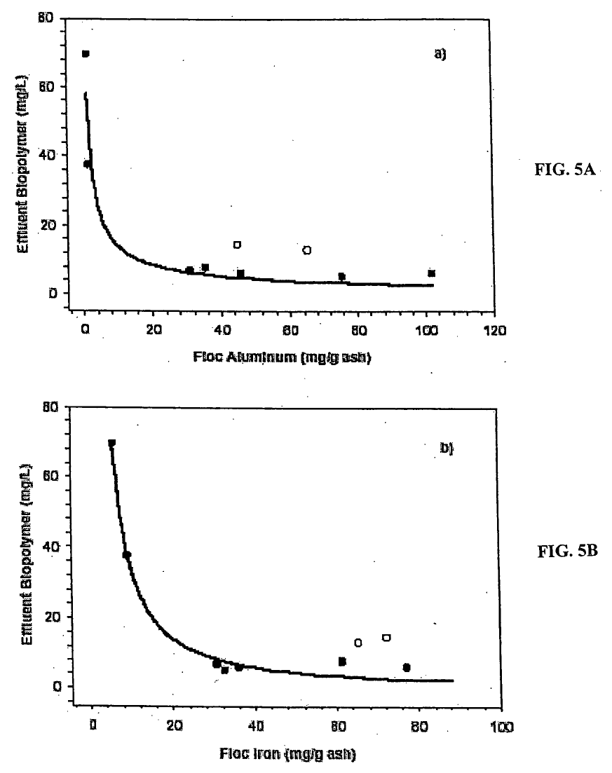

FIG. 4 illustrates that as the sum of iron and aluminum increased in activated sludge floc, less solution biopolymer was found in the plant effluent illustrating that addition of such trivalent cations can improve flocculation and solids removal. The relationship between effluent biopolymer and individual floc trivalent cations, shown in FIG. 5, additionally suggests that iron and aluminum have significant impact on biopolymer binding. It should be noted that in the experiments reflected in FIG. 5, individual cations were not controlled, so the effects of different cations (mono and divalent cations, iron and aluminum) on biopolymer binding are not independent, but rather, reflect the composite cation concentrations.

In certain preferred embodiments, as previously noted, the invention provides such individual control of cation concentration. However, in the illustrated embodiments, high linear correlations between floc cations and effluent biopolymer shown in FIGS. 4 and 5 indicate that iron and aluminum play an important role in binding between biopolymer and activated sludge floc. The data shows that both iron and aluminum have better flocculating ability than divalent cations as illustrated in FIGS. 4 and 5 and are therefore useful as agents to facilitate and improve flocculation during wastewater treatment. By contrast, activated sludges with low iron and aluminum such as WAS B1 and B2 yielded high solution biopolymer in the effluent.

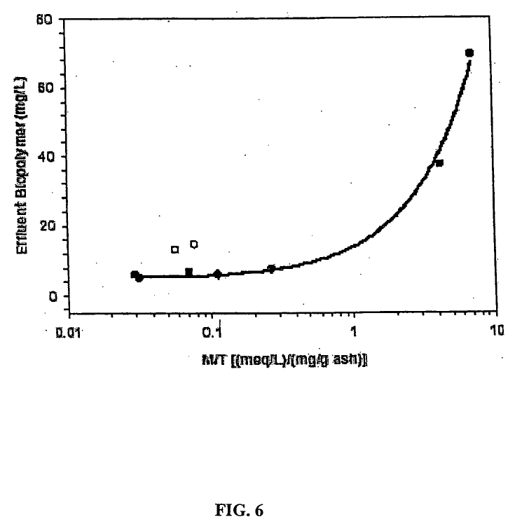

The results also suggest that both the M/D ratio and the floc trivalent cations should be considered and, in some embodiments controlled, together to characterize activated sludge effluent characteristics and improve flocculation and dewatering. One analytical and control approach uses the ratio of monovalent cations to the sum of iron and aluminum (M/T) and this was compared to effluent biopolymer data, as shown in FIG. 6. It can be seen that the M/T ratio correlated well with effluent biopolymer. This might be because sludge samples of the illustrated examples had a relatively low variation in divalent cations (Mg2+=16±6mg/L; Ca2+=31±6mg/L), except for plant E, so that monovalent cations, especially sodium, and iron and aluminum likely determined the characteristics of each sludge. However, if wastewaters contain larger variations in their divalent cation concentration, the M/T ratio might not be as useful for predicting/controlling effluent characteristics.

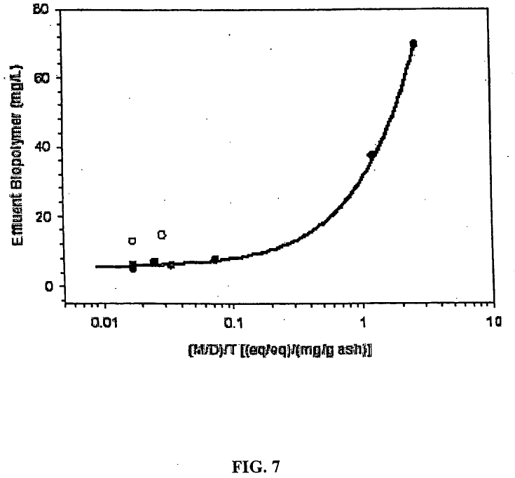

A cation parameter that included both M/D and trivalent cations was also used and the data are presented in FIG. 7. This ratio, (M/D)/T, was obtained by dividing the M/D ratio by the sum of iron and aluminum so the units of this ratio were [(eq/eq)/(mg/g-ash)]. When both (Fe+Al) and (Ca+Mg) increase, the ratio decreases, so, in general, as the value decreases, sludge properties improve.

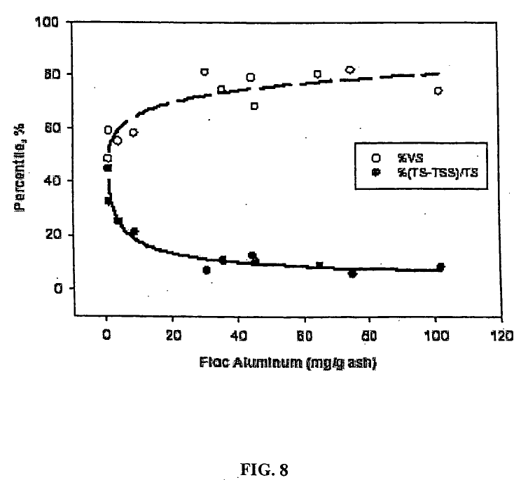

The effect of cations on bioflocculation was also examined using the VS content of the floc and the fraction of solids passing a 1.5 μm filter as indicators of biopolymer binding. The fraction passing a 1.5 μm filter was calculated as (TS-TSS)/TS. The difference between TS and TSS corresponds to materials smaller than 1.5 μm and can be defined as non-flocculated colloidal and dissolved solids so that (TS−TSS)/TS is the fraction of unattached or non-flocculated solids. If bioflocculation is poor, more of the biopolymer would remain free or unattached, so the unflocculated fraction would be high. Simultaneously, the loss of biopolymer into the effluent would result in a lower volatile fraction in the WAS. As expected, the correlation coefficient in Table 4 shows the strong negative correlation between % VS and % (TS−TSS)/TS (rp=−0.92; p<0.01). The relationship between floc aluminum and the VS and unbound solids [(TS−TSS)/TS] for WAS is shown in FIG. 8.

The data show that WAS with low floc aluminum also had a low volatile fraction along with a high fraction of material passing a 1.51 μm filter. Aluminum thus was an efficient collector of solution biopolymer, so as the aluminum of the floc increases, the volatile fraction of the WAS increases and effluent biopolymer decreases. However, once the aluminum content reached about 30 mg/g ash, additional aluminum did not substantially increase the collection of biopolymer. This suggests that there may be an optimum aluminum content for flocculation in activated sludge. Since the pH of the wastewaters utilized for the present examples is near neutral, aluminum is expected to be present as Al(OH)₃. Aluminum or other trivalent cations supplemented as an additive, according to the invention, can thus play an important role in flocculation as shown by its relationship to effluent biopolymer and the volatile fraction of flocs.

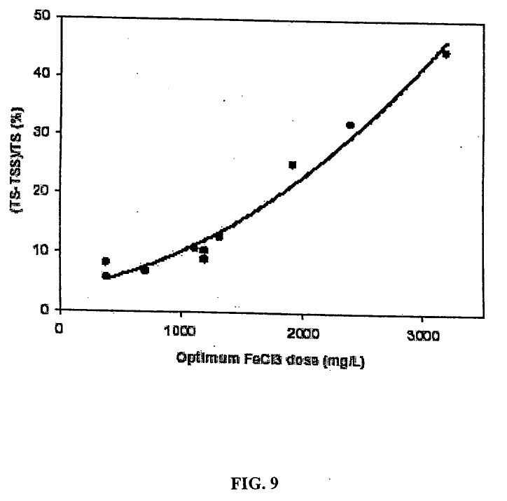

The aggregated floc is dewatered to increase the solids content. Data in FIG. 9 show how the materials in solution (passing a 1.5 μm filter) contribute to the conditioning chemical requirements. The optimum FeCl₃ dose for WAS was well correlated with the materials less than 1.5 μm. It is important to note that units of iron conditioning dose used in this figure were not normalized by dry solids concentration. That is, colloidal and dissolved solids rather than total solids of the WAS are most likely responsible for the iron (III) conditioning demands. This observation might pertain to the previous studies reporting that smaller particles mainly affected sludge dewaterability (see for example, Karr and Keinath, Influence of Particle Size on Sludge Dewaterability, J. Water Poll. Control Fed., 50, 1911, 1978).

In contrast to iron (III), alum and cationic polymer data did not correlate well with % (TS-TSS)/TS. This is thought to occur because these coagulants are more likely influenced by the specific size of solution materials. The analysis of molecular weight separation and biopolymer in each of the molecular weight fractions indicated that both alum and cationic polymer doses were better correlated with the fraction of biopolymer retained between 1.5 μm and 30K than the total biopolymer less than 1.5 μm.

The use of trivalent coagulating agents or trivalent cations in activated sludge according to the invention can improve weak binding of biopolymer and avoid poor effluent quality and lower conditioning chemical requirements. The addition of trivalent cations, such as iron and aluminum, at appropriate amounts into activated sludge process according to the invention can bring significant improvement in those characteristics. With respect to dewatering and conditioning, addition of aluminum is more preferred in some embodiments than iron since iron undergoes reduction under anaerobic conditions, causing physiochemical changes in sludge properties.

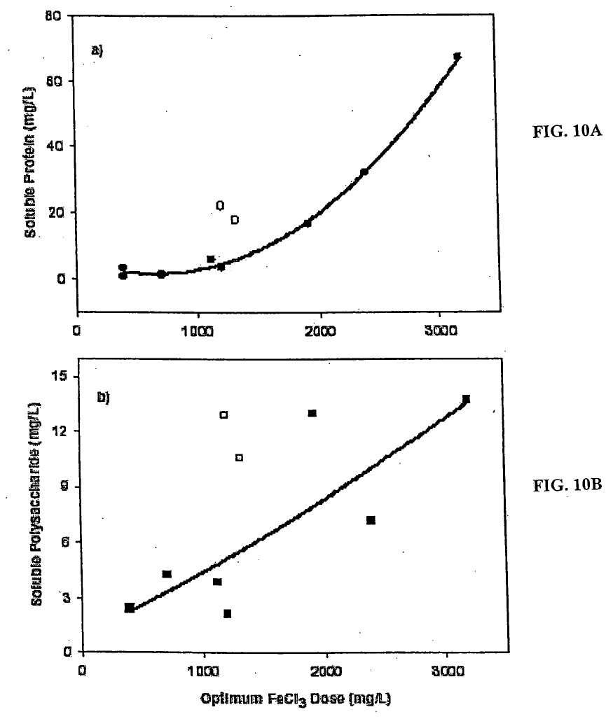

The illustrative examples herein described also show that protein release induced by iron reduction accounted for the VS destruction and poor dewatering rates of sludge during anaerobic digestion. Strong affinity of iron (III) for protein can be seen from FIG. 10. In this figure the optimum FeCl₃ dose was mainly determined by solution protein rather than solution polysaccharide. As a result, while iron in activated sludge can be beneficial for making strong flocs by specifically binding protein, it can be less preferred for embodiments involving sludge dewatering if iron rich-sludge becomes anaerobic. Unlike iron, aluminum and other Group III cations do not intend to undergo reduction and hence may be more preferred for use in such embodiments.

The above exemplary results also illustrate that various characteristics of wastewater were strongly associated with cation content in the influent to a secondary treatment stage. Significantly, effluent quality, as defined by the sum of solution protein and polysaccharide in secondary effluent, responds directly to the iron and aluminum content in floc. Effluent biopolymer was found to decrease as the sum of iron and aluminum in floc increased. Measuring K+ across an activated sludge facility may be useful for indicating microbial upset and poor dewatering rates of WAS. A low trivalent cation concentration in floc can produce sludge with weak biopolymer binding. This weak binding can resulted in high concentrations of biopolymer in solution, causing poor sludge dewatering and high conditioning chemical requirements. Thus, increasing trivalent cation concentrations can improve the wastewater treatment efficiency. Provision and control of the value of cation ratios such as M/T and (M/D)/T can be used to facilitate binding of biopolymer to activated sludge floc and determine the amount of trivalent cation species necessary to achieve a desired performance level. WAS low in trivalent cation concentration can have low volatile fraction but high fraction of dissolved and colloidal phased solids. Thus, trivalent cations can improve bioflocculation and effluent quality.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A waster treatment system comprising a trivalent coagulant source fluidly connected upstream of a secondary treatment stage.

2. The wastewater treatment system of claim 1 wherein the trivalent coagulant comprises an aluminum salt.

3. A method of treating wastewater comprising adding a trivalent cation prior to flocculating sludge in a wastewater treatment facility.

4. The method of claim 3 wherein the trivalent cation facilitating coagulation of biocolloidal material to form flocculent material.

5. A method of treating wastewater comprising adding a trivalent aluminum salt to wastewater to be treated prior to bacterial treatment, forming a flocculated sludge and dewatering the sludge.

6. The method of claim 5, wherein the trivalent aluminum salt is added in an amount such that a ratio of the equivalents of any monovalent cations to any divalent cations relative to the mass of trivalent aluminum salt per mass of solids is less than about 1.0.

7. A method of treating wastewater comprising:
adding a trivalent cation to the wastewater; and
forming a flocculant material while maintaining a (M/D)/T ratio of less than about 1.0,
wherein m represents monovalent cation equivalent concentration in the wastewater, d represents divalent cation equivalent concentration in the wastewater and t represent the mass of the trivalent cations in the flocculent material.

8. A method of treating wastewater comprising:
adding a trivalent cation to the wastewater; and
forming a flocculant material while maintaining a MI/T ratio of less than about 1.0,
wherein M represents monovalent cation equivalent concentration in the wastewater and T represent the mass of the trivalent cations in the flocculent material.

9. A method of facilitating wastewater treatment comprising providing a trivalent cation to a wastewater treatment system for coagulating biocolloidal material.

10. A method of facilitating wastewater treatment comprising supplying a trivalent cation to a wastewater treatment system in a quantity and at a location selected to affect coagulation of biocolloidal material.

11. A method of facilitating the coagulation of biocolloidal material in a wastewater of a wastewater treatment system comprising providing a trivalent cation to the wastewater treatment system.
